(19) United States
(12) Patent Application Publication
(10) Pub. No.: US 2023/0170582 A1
(43) Pub. Date: Jun. 1, 2023

(54) POWER STORAGE CELL, POWER STORAGE DEVICE, AND METHOD FOR MANUFACTURING POWER STORAGE DEVICE

(71) Applicant: KABUSHIKI KAISHA TOYOTA JIDOSHOKKI, Kariya-shi, Aichi (JP)

(72) Inventors: Hirokuni AKIYAMA, Aichi-ken (JP); Shinji SUZUKI, Aichi-ken (JP); Nobukiyo ITO, Aichi (JP); Yusuke YAMASHITA, Kariya-shi, Aichi (JP); Eiji MIZUTANI, Aichi-ken (JP)

(73) Assignee: KABUSHIKI KAISHA TOYOTA JIDOSHOKKI, Kariya-shi, Aichi (JP)

(21) Appl. No.: 17/921,226

(22) PCT Filed: Apr. 23, 2021
(86) PCT No.: PCT/JP2021/016548

§ 371 Date: Oct. 25, 2022

(30) Foreign Application Priority Data
Apr. 30, 2020 (JP) 2020-080355
Jul. 10, 2020 (JP) 2020-119269

(51) Int. Cl. H01M 50/489; H01M 50/46; H01M 50/483; H01M 50/474; H01M 50/209; H01M 4/70

(52) U.S. Cl. CPC H01M 50/489; H01M 50/461; H01M 50/483; H01M 50/474; H01M 50/209; H01M 4/70

(57) ABSTRACT

A power storage cell is provided with a positive electrode, a negative electrode, a separator, and a spacer. The positive electrode has: a first current collector; and a positive electrode active material layer provided on a one surface of the first current collector. The negative electrode has: a second current collector; and a negative electrode active material layer provided on a one surface of the second current collector. The separator has a base material layer, a first adhesive layer, and a second adhesive layer. The one surface of the first current collector is adhered to the first adhesive layer in an edge portion of the separator. The spacer is adhered to the second adhesive layer in the edge portion of the separator.

### TECHNICAL FIELD

The present disclosure relates to a power storage cell, a power storage device, and a method for manufacturing the power storage device.

### BACKGROUND ART

Patent Literature 1 discloses a power storage element having a packaged positive electrode plate in which an adhesion layer provided on a surface of a separator is adhered to a tab of the positive electrode plate.

### CITATION LIST

### Patent Literature

Patent Literature 1: Japanese Patent Application Publication No. 2018-152236

### SUMMARY OF INVENTION

### Technical Problem

In the aforementioned power storage element, the separator may shrink when adhesive force of the separator to the tab is reduced.

The present disclosure provides a power storage cell, a power storage device, and a method for manufacturing the power storage device which may suppress shrinking of the separator.

### Solution to Problem

A power storage cell according to one aspect of the present disclosure includes: a positive electrode having a first current collector and a positive electrode active material layer provided on one surface of the first current collector; a negative electrode having a second current collector and a negative electrode active material layer provided on one surface of the second current collector, the negative electrode being stacked on the positive electrode such that the negative electrode active material layer faces the positive electrode active material layer; a separator disposed between the positive electrode and the negative electrode and having a base material layer; and a spacer positioned between the first current collector and the second current collector and joined to at least one of the first current collector and the second current collector. The separator has a central portion overlapping with the positive electrode active material layer and the negative electrode active material layer as viewed in a stacking direction of the positive electrode and the negative electrode, and an edge portion surrounding the central portion without overlapping the positive electrode active material layer and the negative electrode active material layer. The separator has, at least in the edge portion of the separator, a first adhesion layer provided on a first surface of the base material layer, and a second adhesion layer provided on a second surface of the base material layer. One of the first current collector and the second current collector is adhered to the first adhesion layer in the edge portion of the separator. The spacer is adhered to the second adhesion layer in the edge portion of the separator.

In the aforementioned power storage cell, since the edge portion of the separator is adhered to one of the first current collector and the second current collector and the spacer, which may suppress shrinkage of the separator.

The first adhesion layer and the second adhesion layer may be provided to the central portion of the separator. In this case, the first adhesion layer and the second adhesion layer may be adhered to the positive electrode active material layer and the negative electrode active material layer.

One of the first adhesion layer and the second adhesion layer may be adhered to one of the positive electrode active material layer and the negative electrode active material layer. The other of the first adhesion layer and the second adhesion layer may be adhered to the other of the positive electrode active material layer and the negative electrode active material layer. In this case, even when the active material layer shrinks, a decrease in a contact area between the adhesion layer and the active material layer may be suppressed.

The spacer may be adhered to an end surface of the first adhesion layer and an end surface of the second adhesion layer. In this case, adhesive force between the separator and the spacer is improved.

At least one of the first adhesion layer and the second adhesion layer may contain a thermosetting adhesive. In this case, even when the power storage cell is heated after curing of the thermosetting adhesive, the thermosetting adhesive does not melt. Therefore, the separator may be attached more reliably to one of the first current collector and the second current collector or the spacer.

The first adhesion layer may be adhered to the one surface of the second current collector. At an interface between the second current collector and the spacer in the negative electrode, the spacer reacts with an electrolyte through the second current collector as a catalyst, which may deteriorate the spacer to reduce adhesive force between the separator and the second current collector. Even in such a case, the edge portion of the separator is disposed at the interface between the second current collector and the spacer, which may prevent deterioration of the spacer.

In one of the first current collector and the second current collector adhered to the first adhesion layer, a surface roughness of the one surface may be greater than that of the other surface opposite to the one surface. In this case, a contact area between the first adhesion layer and the one surface increases, and thus adhesive force between the first adhesion layer and the one surface increases.

A power storage device according to one aspect of the present disclosure has a stacked body including a plurality of power storage cells being stacked. The plurality of power storage cells include the aforementioned power storage cell.

In the aforementioned power storage device, shrinkage of the separator may be suppressed.

The power storage device further may include a metal layer provided on an outer surface of the spacer of each of the power storage cells. In this case, the metal layer may prevent gas such as water vapor or oxygen from passing through the spacer.

The power storage device may further include: a pair of holding plates sandwiching the stacked body in a stacking direction of the stacked body; and a current collector plate disposed between each of the pair of holding plates and the stacked body. In this case, the pair of the holding plates may apply a holding load to the stacked body in the stacking direction.

A method for manufacturing a power storage device according to one aspect of the present disclosure includes: a preparation process in which a first electrode unit including a first electrode having a first current collector and a first active material layer provided on one surface of the first current collector is prepared; a preparation process in which a second electrode unit including a second electrode and a spacer is prepared, the second electrode having a second current collector and a second active material layer provided on one surface of the second current collector and having a polarity different from that of the first electrode, the spacer being joined to an edge portion of the second current collector; a stacking process in which the first electrode unit and the second electrode unit are stacked one another such that the second active material layer faces the first active material layer with the separator interposed between the second active material layer and the first active material layer, wherein the separator includes a base material layer, a first adhesion layer provided on a first surface of the base material layer, and a second adhesion layer provided on a second surface of the base material layer, the edge portion of the separator is disposed between the one surface of the second current collector and the spacer, the first adhesion layer in the edge portion of the separator faces the one surface of the second current collector, and the second adhesion layer in the edge portion of the separator faces the spacer; a forming process in which a sealing body that seals a space between the first electrode and the second electrode is formed by the spacer and another spacer disposed side by side in the stacking direction of the first electrode unit and the second electrode unit being joined to each other by welding; and a charging and discharging process in which a power storage device including the first electrode, the second electrode, and the separator is charged and discharged after the formation of the sealing body.

In the method for manufacturing the power storage device, in the stacking process in which the first electrode unit and the second electrode unit are stacked one another or in the charging and discharging process of the power storage device, the first adhesion layer and the second adhesion layer offer their adhesive force due to heat generation of the power storage device during charging and discharging of the power storage device or due to moisture contained inside the power storage device, for example. As a result, the first adhesion layer in the edge portion of the separator is adhered to the one surface of the first current collector. The second adhesion layer in the edge portion of the separator is adhered to the spacer. Thus, shrinkage of the separator may be suppressed.

### Advantageous Effects of Invention

The present disclosure may provide a power storage cell, a power storage device, and a method for the power storage device which may prevent shrinking of a separator.

### BRIEF DESCRIPTION OF DRAWINGS

FIG. 1 is a schematic cross-sectional view illustrating a power storage device according to an embodiment.

FIG. 2(a) to FIG. 2(d) are cross-sectional views illustrating processes of a method for manufacturing the power storage device according to the embodiment.

FIG. 3 is a cross-sectional view illustrating one of the processes of the method for manufacturing the power storage device according to the embodiment.

FIG. 4 is a schematic cross-sectional view illustrating a power storage device according to another embodiment.

FIG. 5 is a schematic cross-sectional view illustrating a power storage device according to another embodiment.

FIG. 6 is a schematic cross-sectional view illustrating a part of a power storage device according to another embodiment.

### DESCRIPTION OF EMBODIMENTS

Hereinafter, embodiments of the present disclosure will be described in detail with reference to the drawings. In the description of the drawings, the same or equivalent parts are designated by the same signs, and the redundant descriptions thereof are omitted.

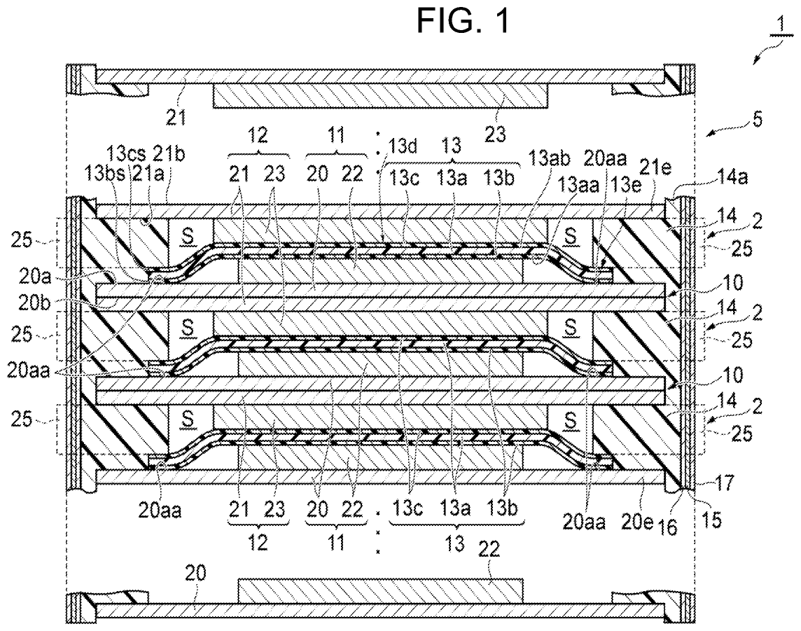

FIG. 1 is a schematic cross-sectional view illustrating a power storage device according to an embodiment. A power storage device 1 illustrated in FIG. 1 is a power storage module used for a battery of various vehicles such as a forklift, a hybrid vehicle, and an electric vehicle. The power storage device 1 is a rechargeable battery such as a nickel-hydrogen secondary battery or a lithium-ion secondary battery. The power storage device 1 may be an electric double-layer capacitor or an all-solid-state battery. In the present embodiment, an example of a case where the power storage device 1 is the lithium-ion secondary battery will be described.

The power storage device 1 includes a cell stack (a stacked body) 5 in which a plurality of power storage cells 2 are stacked in a stacking direction thereof. Hereinafter, a direction in which the plurality of power storage cells 2 are stacked is simply referred to as a stacking direction. The power storage device 1 has a rectangular shape with each side of 50 cm or more, for example, as viewed in the stacking direction. The plurality of power storage cells 2 each include a positive electrode 11, a negative electrode 12, a separator 13, and a spacer 14, as illustrated in FIG. 1. The positive electrode 11 has a first current collector 20 and a positive electrode active material layer 22 provided on one surface 20a of the first current collector 20. The positive electrode 11 is a rectangular electrode, for example, as viewed in the stacking direction. The negative electrode 12 has a second current collector 21 and a negative electrode active material layer 23 provided on one surface 21a of the second current collector 21. The negative electrode 12 is a rectangular electrode, for example, as viewed in the stacking direction. The negative electrode 12 is stacked on the positive electrode 11 such that the negative electrode active material layer 23 faces the positive electrode active material layer 22 in the stacking direction. That is, a direction in which the positive electrode 11 faces the negative electrode 12 coincides with the stacking direction. In the present embodiment, the positive electrode active material layer 22 and the negative electrode active material layer 23 each have a rectangular shape. The negative electrode active material layer 23 is slightly larger than the positive electrode active material layer 22, and an entire forming area in which the positive electrode active material layer 22 is provided is positioned in a forming area in which the negative electrode active material layer 23 is provided, as viewed in the stacking direction.

The first current collector 20 has the other surface 20b that is opposite to the one surface 20a. The positive electrode active material layer 22 is not provided on the other surface 20b. The second current collector 21 has the other surface 21b that is opposite to the one surface 21a. The negative electrode active material layer 23 is not provided on the other surface 21b. The power storage cells 2 are stacked so that the other surface 20b of the first current collector 20 and the other surface 21b of the second current collector 21 are in contact, thereby forming the cell stack 5. As a result, the power storage cells 2 are electrically connected in series. In the cell stack 5, the power storage cells 2, 2 disposed side by side in the stacking direction cooperate to form a simulated bipolar electrode 10 in which the first current collector 20 and the second current collector 21 in contact with each other serve as an electrode body. That is, the bipolar electrode 10 has the first current collector 20, the second current collector 21, the positive electrode active material layer 22, and the negative electrode active material layer 23. The first current collector 20 corresponding to a terminating electrode is disposed on one end in the stacking direction. The second current collector 21 corresponding to the terminating electrode is disposed on the other end in the stacking direction.

Each of the first current collector 20 and the second current collector 21 (hereinafter, may be simply referred to as a “current collector”) is an electrical conductor that is chemically inactive for allowing continuous flow of electric current through the positive electrode active material layer 22 and the negative electrode active material layer 23 during discharging or charging of the lithium-ion secondary battery. The current collector may be made of a metal material, a conductive resin material, and a conductive inorganic material, for example. The conductive resin material may be a conductive polymer material or a resin obtained by adding a conductive filler to a non-conductive polymer material as needed, for example. The current collector may include at least one layer made of the aforementioned metal material or conductive resin material. A surface of the current collector may be covered with a known protective layer. A coating layer may be provided on the surface of the current collector by a known method such as a plating process or spray coating. A carbon film may be provided on the surface of the current collector (on the one surface 20a and the one surface 21a, for example). The current collector may be formed in a plate shape, a foil shape, a sheet shape, a film shape, or a mesh shape, for example. When the current collector is a metal foil, an aluminum foil, a copper foil, a nickel foil, a titanium foil, or a stainless-steel foil may be used, for example. When the aluminum foil, the copper foil, or the stainless-steel foil is used for the current collector, a mechanical strength of the current collector may be secured. The current collector may be an alloy foil or a clad foil of the aforementioned metal materials, or may have a metal plating film provided on one side of the metal foil. In the present embodiment, the first current collector 20 is the aluminum foil, and the second current collector 21 is the copper foil. When a foil-shaped current collector is used, a thickness of the current collector may be 1 μm to 100 μm.

The positive electrode active material layer 22 contains a positive electrode active material capable of occluding and releasing a charge carrier such as a lithium ion. Examples of the positive electrode active material include a lithium composite metal oxide having a layered rocksalt structure, a metal oxide having a spinel structure, and a polyanionic compound that can be used for the lithium-ion secondary battery. The positive electrode active material layer 22 may contain two or more kinds of positive electrode active materials in combination. In the present embodiment, the positive electrode active material layer 22 contains olivine-type lithium iron phosphate (LiFePO₄) as the polyanionic compound.

The negative electrode active material layer 23 may contain any negative electrode active material as long as the negative electrode active material is a simple substance, an alloy or a compound capable of occluding and releasing a charge carrier such as a lithium ion. The negative electrode active material may be lithium, carbon, a metal compound, or an element capable of being alloyed with lithium or a compound thereof, for example. The carbon may be natural graphite, synthetic graphite, or hard carbon (non-graphitizable carbon), or soft carbon (easily graphitizable carbon), for example. The synthetic graphite may be highly oriented graphite or mesocarbon microbeads, for example. The element capable of being alloyed with lithium may be silicon or tin, for example. In the present embodiment, the negative electrode active material layer 23 contains graphite as the carbon.

Each of the positive electrode active material layer 22 and the negative electrode active material layer 23 (hereinafter, may be simply referred to as an “active material layer”) may further contain a conductive assistant, a binder, an electrolyte (a polymer matrix, an ionic conductive polymer, an electrolytic solution, etc.) for increasing electrical conductivity, and electrolyte supporting salt (lithium salt) for increasing ionic conductivity, as needed, for example. Components contained in the active material layer or a compounding ratio of the components, and the thickness of the active material layer may be defined appropriately with reference to public knowledge for the lithium-ion secondary battery. The thickness of the active material layer is 2 μm to 150 μm, for example. A known method such as a roll coating method may be used to form the active material layer on the surface of the current collector. In order to improve thermal stability of the positive electrode 11 or the negative electrode 12, a heat-resistant layer may be provided on the surface (one side or both sides) of the current collector or the surface of the active material layer. The heat-resistant layer may contain, for example, inorganic particles and the binder, and may also contain an additive such as a thickener.

The conductive assistant is added in order to increase conductivity of the positive electrode 11 or the negative electrode 12. For example, the conductive assistant may be acetylene black, carbon black, or graphite.

Examples of the binder include fluorine-containing resins such as polyvinylidene fluoride, polytetrafluoroethylene, and fluorine rubber, thermoplastic resins such as polypropylene and polyethylene, imide-based resins such as polyimide and polyamide-imide, alkoxysilyl group-containing resins, acrylic resins such as polyacrylic acid resin and polymethacrylic acid resin, styrene-butadiene rubber (SBR), carboxymethyl cellulose (CMC), alginates such as sodium alginate and ammonium alginate, water-soluble cross-linked cellulose ester, and starch-acrylic acid graft polymers. One of these binders may be used alone, or two or more of them may be used. Water, N-methyl-2-pyrrolidone (NMP), or the like is used as a solvent.

The separator 13 separates the positive electrode 11 and the negative electrode 12 and allows the charge carrier such as the lithium ion to pass therethrough while preventing a short circuit due to a contact between the positive electrode 11 and the negative electrode 12. The separator 13 is disposed between the positive electrode 11 and the negative electrode 12. The separator 13 prevents a short circuit between the bipolar electrodes 10, 10 disposed side by side when the power storage cells 2 are stacked.

The separator 13 has a base material layer 13a, a first adhesion layer 13b provided on a first surface 13aa of the base material layer 13a, and a second adhesion layer 13c provided on a second surface 13ab of the base material layer 13a, the second surface 13ab opposite to the first surface 13aa. The separator 13 has a central portion 13d overlapping with the positive electrode active material layer 22 and the negative electrode active material layer 23 as viewed in a stacking direction of the positive electrode 11 and the negative electrode 12, an edge portion 13e surrounding the central portion 13d of the separator 13 without overlapping with the positive electrode active material layer 22 and the negative electrode active material layer 23, and a connecting part connecting the central portion 13d and the edge portion 13e of the separator 13. The first adhesion layer 13b and the second adhesion layer 13c are provided to at least the edge portion 13e of the separator 13.

In the present embodiment, the first adhesion layer 13b is also provided to the central portion 13d of the separator 13. That is, the first adhesion layer 13b is provided on the entire first surface 13aa of the base material layer 13a. The first adhesion layer 13b is adhered to the positive electrode active material layer 22. The first adhesion layer 13b prevents positional displacement between the positive electrode 11 and the base material layer 13a.

In the present embodiment, the second adhesion layer 13c is also provided to the central portion 13d of the separator 13. That is, the second adhesion layer 13c is provided on the entire second surface 13ab of the base material layer 13a. The second adhesion layer 13c is adhered to the negative electrode active material layer 23. The second adhesion layer 13c prevents positional displacement between the negative electrode 12 and the base material layer 13a.

The base material layer 13a may be, for example, a porous sheet or a non-woven fabric containing a polymer that absorbs and holds an electrolyte. As a material for the base material layer 13a, for example, a porous film made of polypropylene (PP) is used. As the material for the base material layer 13a, a woven fabric or a non-woven fabric made of polypropylene, methyl cellulose, or the like may be used. The base material layer 13a may have a single-layer structure or a multi-layer structure. The multi-layer structure may have, for example, an adhesion layer, a ceramic layer as the heat-resistant layer, and the like. The base material layer 13a may be impregnated with the electrolyte. The base material layer 13a may be formed of the electrolyte such as a polymer solid electrolyte or an inorganic solid electrolyte.

The electrolyte impregnated in the base material layer 13a may be a liquid electrolyte (electrolyte solution) containing a non-aqueous solvent and an electrolyte salt dissolved in the non-aqueous solvent, or a polymer gel electrolyte containing an electrolyte held in the polymer matrix.

For the electrolytic solution impregnated in the base material layer 13a, a known lithium salt such as LiClO₄, LiAsF₆, LiPF₆, LiBF₄, LiCF₃SO₃, LiN(FSO₂)₂, or LiN(CF₃SO₂)₂ may be used as the electrolyte salt. Known solvents such as cyclic carbonates, cyclic esters, chain carbonates, chain esters, or ethers may be used as the non-aqueous solvent. Two or more of these known solvents may be used in combination.

Each of the first adhesion layer 13b and the second adhesion layer 13c may contain a thermosetting adhesive or a thermoplastic adhesive, or an adhesive (moisture-curable adhesive) that is solidified by reacting with moisture of the electrolytic solution, for example. The moisture-curable adhesive may be solidified at a temperature higher than an operating temperature (for example, a normal temperature) of the power storage device 1. When an ester-based electrolytic solution is used, the moisture-curable adhesive may be solidified at 80° C. or lower. The thermosetting adhesive may contain a thermosetting resin such as an epoxy resin or a phenol resin. The thermoplastic adhesive may contain a thermoplastic resin such as polyethylene, polypropylene, or polyvinylidene fluoride (PVDF). Each of the first adhesion layer 13b and the second adhesion layer 13c may be formed by applying the adhesive.

The spacer 14 is positioned at least between the first current collector 20 and the second current collector 21, and is joined or fixed to the first current collector 20 and the second current collector 21. The spacer 14 is made of an insulating material and insulates the first current collector 20 from the second current collector 21, which prevents the short circuit between the first current collector 20 and the second current collector 21. In the present embodiment, the spacer 14 contains acid-modified polyethylene which is a resin as the insulating material. As a material for the spacer 14, in addition to the acid-modified polyethylene, polyethylene (PE), polystyrene (PS), ABS resin, polypropylene (PP), modified polypropylene (modified PP), and acrylonitrile styrene (AS) resin may be used, for example.

In the present embodiment, the spacer 14 is a frame extending along at least one of an edge portion 20e of the first current collector 20 and an edge portion 21e of the second current collector 21 and surrounding at least one of the positive electrode active material layer 22 and the negative electrode active material layer 23.

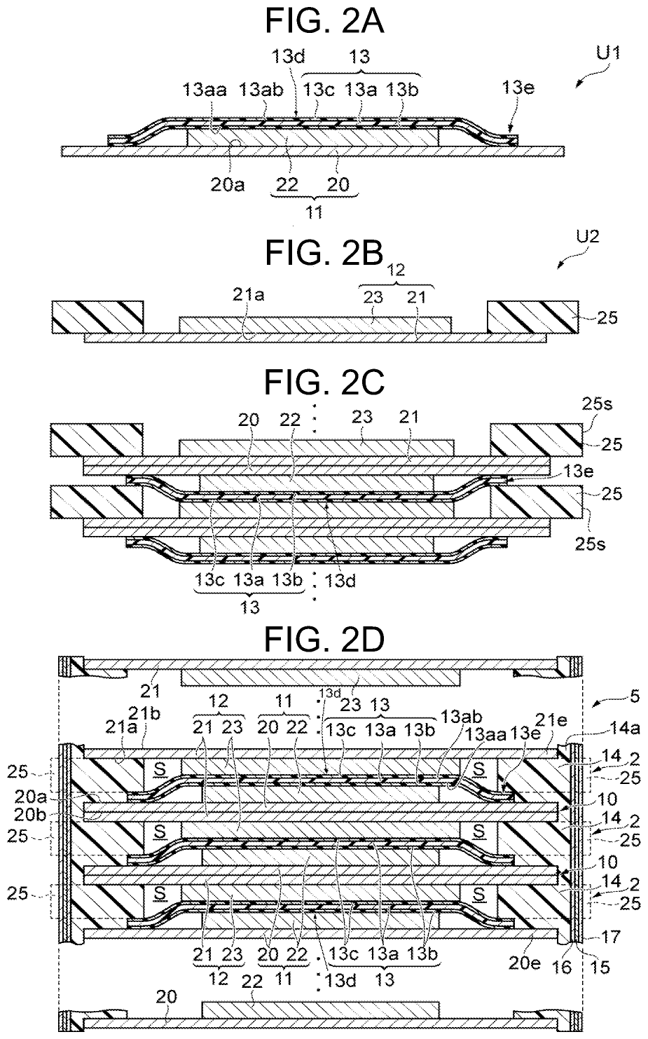

In the present embodiment, the spacer 14 serves as a sealing portion that seals a space S between the positive electrode 11 and the negative electrode 12. In the present embodiment, the spacer 14 that is one of a plurality of spacers 14 each disposed in the power storage cell 2 has a portion disposed between the pair of current collectors and a portion extending outward from the edge portions of the current collectors, and portions extending outward of spacers 14 disposed side by side in the stacking direction of the cell stack 5 are joined to be integrated. The spacers 14 disposed side by side are integrated to form a sealing body 14a. The space S surrounded by the spacer 14, the positive electrode 11, and the negative electrode 12 is filled with the electrolyte (electrolyte solution) impregnated in the base material layer 13a of the separator 13. The spacer 14 has a rectangular frame shape as viewed in the stacking direction, and is adhered to the edge portion 21e of the second current collector 21. The sealing body 14a extends in the cell stack 5 in the stacking direction thereof from the first current collector 20 disposed at the one end of the cell stack 5 in the stacking direction to the second current collector 21 disposed at the other end in the stacking direction. The sealing body 14a is a tubular member. The sealing body 14a is formed by a plurality of resin frames 25 being joined to each other by welding (see FIG. 2), as described below.

The spacer 14 seals the space S between the positive electrode 11 and the negative electrode 12, which prevents the electrolyte from passing through the space S and prevents moisture from entering the space S from an outside of the power storage device 1. Furthermore, the spacer 14 may prevent gas generated from the positive electrode 11 or the negative electrode 12 from leaking to the outside of the power storage device 1 due to a charge or discharge reaction, for example.

In the present embodiment, the one surface 20a of the first current collector 20 is adhered to the first adhesion layer 13b in the edge portion 13e of the separator 13. That is, the one surface 20a of the first current collector 20 includes an adhesion surface 20aa adhered to the first adhesion layer 13b. The one surface 20a of the first current collector 20 includes a forming area in which the positive electrode active material layer 22 is provided and a non-forming area in which the positive electrode active material layer 22 is not provided. The non-forming area includes the adhesion surface 20aa that is located around the forming area and adhered to the first adhesion layer 13b.

The spacer 14 is adhered to the second adhesion layer 13c in the edge portion 13e of the separator 13. The spacer 14 may be adhered to an end surface 13bs of the first adhesion layer 13b and an end surface 13cs of the second adhesion layer 13c. The edge portion 13e of the separator 13 is disposed between the adhesion surface 20aa and the spacer 14. The edge portion 13e of the separator 13 is embedded in the spacer 14.

In the power storage device 1 and the power storage cells 2 of the present embodiment, since the edge portion 13e of the separator 13 is adhered to the first current collector 20 and the spacer 14, the edge portion 13e of the separator 13 is fixed, which may suppress shrinkage or positional displacement of the separator 13.

The edge portion 13e of the separator 13 of the present embodiment is not only adhered to one of the current collectors on one surface of the edge portion 13e but also to the spacer 14 adhered and fixed to the other of the current collectors on the other surface of the edge portion 13e. The spacer 14 is disposed in a fixed state at an end of each of the storage cells 2. Thus, the edge portion 13e of the separator 13 is supported by the spacer 14 even when adhesive force between the one surface of the edge portion 13e of the separator 13 and the one current collector is reduced. Therefore, in the present embodiment, the shrinkage of the separator 13 is suppressed as compared with a case in which the edge portion 13e of the separator 13 is not adhered to any part, or a case in which the edge portion 13e of the separator 13 is adhered only to the one current collector. As a result, the short circuit between the positive electrode and the negative electrode due to heat shrinkage of the separator 13 may be suppressed. The positive electrode active material layer 22 and the negative electrode active material layer 23 repeatedly expand and shrink, so that a gap may be formed between the electrodes and the separator due to an influence of residual stress and the like. However, the first adhesion layer 13b and the second adhesion layer 13c reduce extension of a distance between the one surface 20a of the first current collector 20 and the one surface 21a of the second current collector 21, which may prevent deterioration of a battery performance.

When the first adhesion layer 13b and the second adhesion layer 13c are provided to the central portion 13d of the separator 13, the first adhesion layer 13b and the second adhesion layer 13c may be adhered to the positive electrode active material layer 22 and the negative electrode active material layer 23, respectively.

When the positive electrode active material layer 22 or the negative electrode active material layer 23 repeatedly expands and shrinks, a gap may be formed between the electrodes and the separator due to an influence of residual stress, for example. However, the first adhesion layer 13b is adhered to the positive electrode active material layer 22, and the second adhesion layer 13c is adhered to the negative electrode active material layer 23, which may reduce the extension of the distance between the positive electrode active material layer 22 and the negative electrode active material layer 23. As a result, an increase in an electric resistance value of the power storage device 1 is reduced, so that a decrease in a capacity of the power storage device 1 may be prevented. When a size of the power storage device 1 is large as viewed in the stacking direction as in the present embodiment, the distance between the current collectors in the central portion 13d of the power storage device 1 becomes large. Even in such a case, in the central portion 13d of the separator 13, the first adhesion layer 13b and the second adhesion layer 13c are adhered to the positive electrode active material layer 22 and the negative electrode active material layer 23, respectively, which may suppress the extension of the distance between the one surface 20a of the first current collector 20 and the one surface 21a of the second current collector 21 in the central portion 13d of the power storage device 1 as viewed in the stacking direction.

When the spacer 14 is adhered to an end surface 13bs of the first adhesion layer 13b and an end surface 13cs of the second adhesion layer 13c, an adhesion area between the separator 13 and the spacer 14 becomes large. Thus, the separator 13 may be more firmly adhered to the spacer 14.

In a case in which at least one of the first adhesion layer 13b and the second adhesion layer 13c contains the thermosetting adhesive, the thermosetting adhesive does not melt even when the power storage cells 2 are heated after curing of the thermosetting adhesive. Therefore, the separator 13 may be attached more reliably to the first current collector 20 or the spacer 14.

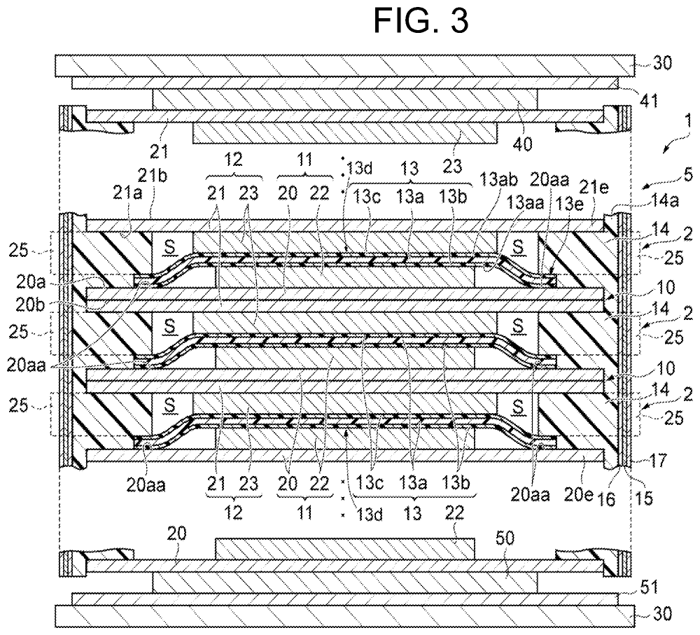

FIG. 2(a) to FIG. 2(d) and FIG. 3 are cross-sectional views illustrating processes of a method for manufacturing a power storage device according to an embodiment. The power storage device 1 may be manufactured, for example, as follows.

### Preparation of Positive Electrode Unit

Firstly, a positive electrode unit U1 (a first electrode unit) is prepared, as illustrated in FIG. 2(a). The positive electrode unit U1 includes the positive electrode 11 (a first electrode) having the first current collector 20 and the positive electrode active material layer 22 (a first active material layer) provided on the one surface 20a of the first current collector 20. In the present embodiment, the positive electrode unit U1 includes the separator 13 provided on the one surface 20a of the first current collector 20. The separator 13 covers the positive electrode active material layer 22. The separator 13 includes the base material layer 13a, the first adhesion layer 13b provided on the first surface 13aa of the base material layer 13a, and the second adhesion layer 13c provided on the second surface 13ab of the base material layer 13a. A part of the first adhesion layer 13b in the edge portion 13e of the separator 13 faces the one surface 20a of the first current collector 20. Such a part of the first adhesion layer 13b in the edge portion 13e of the separator 13 may be adhered to the one surface 20a of the first current collector 20. In the aforementioned process, when the first adhesion layer 13b and the second adhesion layer 13c of the separator 13 contain the thermosetting adhesive, the thermosetting adhesive is uncured but has adhesive force to the one surface 20a of the first current collector 20.

### Preparation of Negative Electrode Unit

Then, as illustrated in FIG. 2(b), a negative electrode unit U2 (a second electrode unit) is prepared. The negative electrode unit U2 includes the second current collector 21, the negative electrode 12 (a second electrode having polarity different from that of the first electrode) having the negative electrode active material layer 23 (a second active material layer) provided on the one surface 21a of the second current collector 21, and one of the resin frames 25 (a spacer) joined to the edge portion 21e of the second current collector 21. An electrolytic solution may be supplied into the one of the resin frames 25.

### Stacking of Positive Electrode Unit and Negative Electrode Unit

Next, as illustrated in FIG. 2(c), the positive electrode unit U1 and the negative electrode unit U2 are stacked one another such that the negative electrode active material layer 23 faces the positive electrode active material layer 22 with the separator 13 interposed therebetween. The edge portion 13e of the separator 13 is disposed between the one surface 20a of the first current collector 20 and the one of the resin frames 25. A part of the first adhesion layer 13b in the edge portion 13e of the separator 13 faces the one surface 20a of the first current collector 20. A part of the second adhesion layer 13c in the edge portion 13e of the separator 13 faces the one of the resin frames 25. The plurality of resin frames 25 are distanced from each other and stacked in the stacking direction of the positive electrode unit U1 and the negative electrode unit U2.

### Formation of Sealing Body

Next, as illustrated in FIG. 2(d), the resin frames 25 disposed side by side in the stacking direction of the positive electrode unit U1 and the negative electrode unit U2 are joined to each other by welding, thereby forming the sealing body 14a that seals the respective space S between the positive electrode 11 and the negative electrode 12. For example, a heat plate is pressed to outer peripheral surfaces 25s of the resin frames 25, so that the resin frames 25 disposed side by side are joined to each other by welding.

### Charging and Discharging of Power Storage Device

Next, as illustrated in FIG. 3, charging and discharging of the power storage device 1 including the positive electrode 11, the negative electrode 12, and the separator 13 are performed (an activation process). In the present embodiment, charging and discharging of the power storage device 1 are performed in a state in which the positive electrode 11, the negative electrode 12, and the separator 13 are held in the stacking direction. In the stacking direction, the power storage device 1 is held by sandwiching the power storage device 1 between a pair of holding members 30. A positive electrode current collector plate 40 electrically connected to the first current collector 20 is disposed between one of the holding members 30 and the first current collector 20 disposed at the one end in the staking direction. An insulating plate 41 is disposed between the positive electrode current collector plate 40 and the one of the holding members 30. A negative electrode current collector plate 50 electrically connected to the second current collector 21 is disposed between the other of the holding members 30 and the second current collector 21 disposed at the other end in the stacking direction. An insulating plate 51 is disposed between the negative electrode current collector plate 50 and the other of the holding members 30.

The power storage device 1 held by the pair of holding members 30 is placed inside a constant temperature water bath, and current flows between the positive electrode current collector plate 40 and the negative electrode current collector plate 50, whereby charging and discharging (initial charging and discharging) of the power storage device 1 are performed.

After the activation process, holding by the pair of holding members 30 is released and the power storage device 1 is removed. As described above, the power storage device 1 may be manufactured.

In the method for manufacturing the power storage device 1 of the present embodiment, when the first adhesion layer 13b and the second adhesion layer 13c contain the thermosetting adhesive, in the process of charging and discharging of the power storage device 1, the first adhesion layer 13b and the second adhesion layer 13c are cured by heat generation of the power storage device 1 (for example, 90° C.) during charging and discharging of the power storage device 1. As a result, the first adhesion layer 13b in the edge portion 13e of the separator 13 is adhered to the adhesion surface 20aa of the one surface 20a of the first current collector 20. A part of the second adhesion layer 13c in the edge portion 13e of the separator 13 is adhered to the spacer 14. The edge portion 13e of the separator 13 is disposed between the adhesion surface 20aa on the one surface 20a of the first current collector 20 and the spacer 14. Accordingly, shrinkage of the separator 13 can be suppressed.

When the first adhesion layer 13b and the second adhesion layer 13c contain the thermoplastic adhesive, in the stacking process of the positive electrode unit and the negative electrode unit, the first adhesion layer 13b and the second adhesion layer 13c are adhered to the adhesion surface 20aa and the spacer 14, respectively, by thermal press fitting. When the first adhesion layer 13b and the second adhesion layer 13c contain the moisture-curable adhesive, in the stacking process of the positive electrode unit and the negative electrode unit, the first adhesion layer 13b and the second adhesion layer 13c are adhered to the adhesion surface 20aa and the spacer 14, respectively, by reaction with the moisture of the electrolytic solution dripped in each of the resin frames 25.

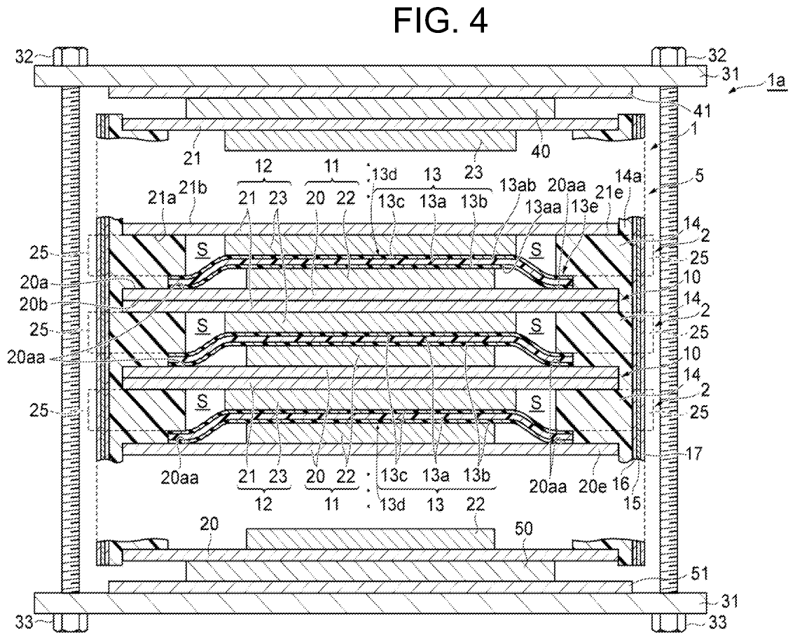

FIG. 4 is a schematic cross-sectional view illustrating a power storage device according to another embodiment. A power storage device 1a illustrated in FIG. 4 includes the power storage device 1 in FIG. 1, a pair of holding plates 31, the positive electrode current collector plate 40, and the negative electrode current collector plate 50. The pair of holding plates 31 sandwiches the power storage device 1, the positive electrode current collector plate 40, and the negative electrode current collector plate 50 in the stacking direction of the cell stack 5. The pair of holding plates 31 is connected to each other by fastening members such as bolts 32 and nuts 33. The positive electrode current collector plate 40 is disposed between one of the holding plates 31 and the first current collector 20 disposed at the one end in the stacking direction. An insulating plate 41 is disposed between the positive electrode current collector plate 40 and the one of the holding plates 31. The negative electrode current collector plate 50 is disposed between the other of the holding plates 31 and the second current collector 21 disposed at the other end in the stacking direction. An insulating plate 51 is disposed between the negative electrode current collector plate 50 and the other of the holding plates 31.

Even in the power storage device 1a, the same effect as the power storage device 1 can be obtained. In addition, the pair of the holding plates 31 applies a holding load to the cell stack 5 in the stacking direction. The power storage device 1a may be manufactured by the same method as the power storage device 1.

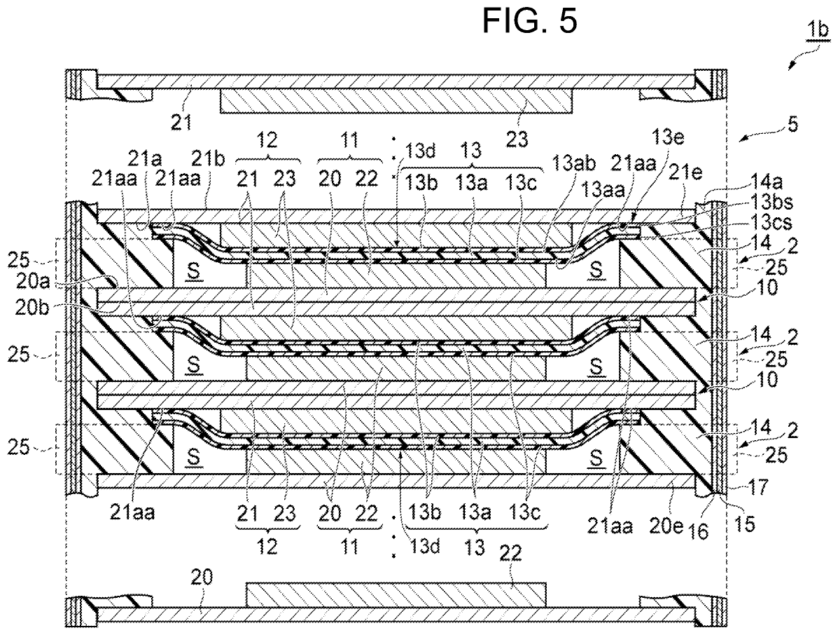

FIG. 5 is a schematic cross-sectional view illustrating a power storage device according to another embodiment. A power storage device 1b illustrated in FIG. 5 has the same configuration as the power storage device 1 of FIG. 1, except that the edge portion 13e of the separator 13 is adhered to the one surface 21a of the second current collector 21 instead of the one surface 20a of the first current collector 20. That is, in the power storage device 1b, positions of the positive electrode 11 and the negative electrode 12 in the power storage device 1 of FIG. 1 are switched and a position of the separator 13 is thus turned upside down. Therefore, in the power storage device 1b, the one surface 21a of the second current collector 21 has an adhesion surface 21aa to which a part of the first adhesion layer 13b in the edge portion 13e of the separator 13 is adhered. In this case, a part of the second adhesion layer 13c in the edge portion 13e of the separator 13 is adhered to the spacer 14.

Even in the power storage device 1b, the same effect as the power storage device 1 can be obtained. At an interface between the second current collector 21 and the spacer 14 in the negative electrode 12, the spacer 14 (for example, the resin) reacts with the electrolyte through the second current collector 21 (for example, the copper) as a catalyst, which may deteriorate the spacer 14. Even in such a case, the edge portion 13e of the separator 13 is disposed at the interface between the second current collector 21 and the spacer 14, which may prevent deterioration of the spacer 14. When the negative electrode active material layer 23 of the negative electrode 12 is graphite and the positive electrode active material layer 22 of the positive electrode 11 is olivine-type lithium iron phosphate, the negative electrode active material layer 23 is softer than the positive electrode active material layer 22. Thus, in the present embodiment, the separator 13 is adhered to the second current collector 21 on which the negative electrode active material layer 23 is provided, which prevents the separator 13 from being damaged at corners of the active material layers. Furthermore, the separator 13 covers the negative electrode active material layer 23 whose area is larger than that of the positive electrode active material layer 22, which may prevent the negative electrode active material layer 23 from being peeled from the second current collector 21.

The power storage device 1b may be manufactured by the same method as the power storage device 1. In a preparation process of the positive electrode unit, the positive electrode unit including the positive electrode 11 and one of the resin frames 25 is prepared. In the preparation process of the negative electrode unit, the negative electrode unit including the negative electrode 12 and the separator 13 is prepared. Then, the positive electrode unit and the negative electrode unit are stacked after the electrolytic solution is supplied into the one of the resin frames 25 of the positive electrode unit.

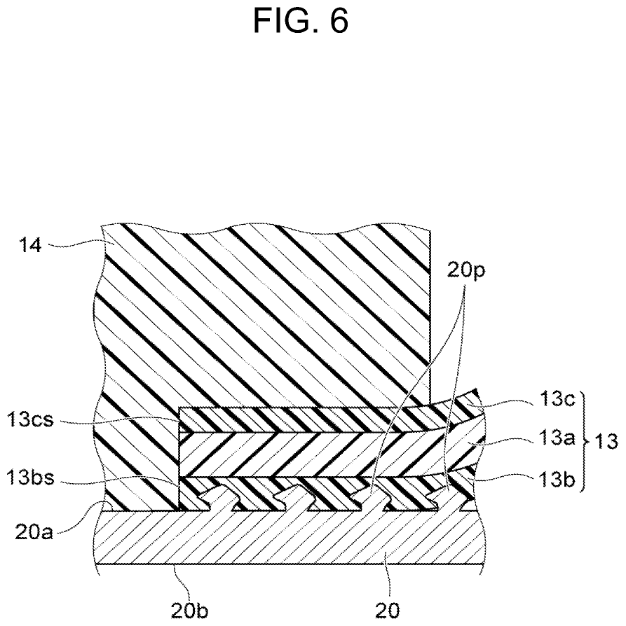

FIG. 6 is a schematic cross-sectional view illustrating a part of a power storage device according to another embodiment. The power storage device illustrated in FIG. 6 has the same configuration as the power storage device 1 of

FIG. 1, except that the one surface 20a of the first current collector 20 is roughened. Although only the adhesion surface 20aa is roughened, in the present embodiment, the entire one surface 20a of the first current collector 20 is roughened. The surface roughness (arithmetic average roughness: Ra) of the one surface 20a of the first current collector 20 is greater than that of the other surface 20b of the first current collector 20. When the entire one surface 20a of the first current collector 20 is roughened, the surface roughness of the entire one surface 20a of the first current collector 20 is simply required to be greater than the surface roughness of the entire other surface 20b of the first current collector 20. When only the adhesion surface 20aa of the first current collector 20 is roughened, the surface roughness of the adhesion surface 20aa of the first current collector 20 is simply required to be greater than the surface roughness of the entire other surface 20b of the first current collector 20. The surface roughness of the one surface 20a is 50 μm to 300 μm, for example. The other surface 20b is a smooth surface, for example, but may be roughened. The one surface 20a has a plurality of protrusions 20p protruding in the stacking direction, for example. The plurality of protrusions 20p are disposed inside the first adhesion layer 13b. That is, a height of each of the protrusions 20p is smaller than a thickness of the first adhesion layer 13b. The first adhesion layer 13b is introduced into recesses formed between the protrusions 20p disposed side by side, which offers an effect of anchoring.

Each of the protrusions 20p has a narrow part at a position between a proximal end and a distal end of each of the protrusions 20p, for example. In other words, each of the protrusions 20p has an overhang portion between the proximal end and the distal end. Specifically, each of the protrusions 20p has an expansion portion whose diameter increases from the proximal end to the distal end and a reduction portion whose diameter decreases from the proximal end to the distal end. The plurality of protrusions 20p each having the narrow part may further enhance the effect of anchoring. FIG. 6 is merely a schematic view, and the protrusions 20p have any size, shape, density, and the like. The protrusions 20p may be formed by electrolytic plating or by etching. The protrusions 20p may each have a tapered shape from the proximal end to the distal end, for example.

In the power storage device of FIG. 6, a contact area between the first adhesion layer 13b and the one surface 20a is increased, which improves adhesive force between the first adhesion layer 13b and the one surface 20a. Thus, shrinkage of the separator 13 may be further suppressed.

The other surface 20b of the first current collector 20 comes into contact with the other surface 21b of the second current collector 21, between the power storage cells 2 disposed side by side. When the other surface 20b of the first current collector 20 and the other surface 21b of the second current collector 21 are smooth surfaces, a contact resistance between the first current collector 20 and the second current collector 21 is reduced.

Similarly, also in the power storage device 1a of FIG. 4, the surface roughness of the one surface 20a of the first current collector 20 may be greater than that of the other surface 20b of the first current collector 20. Similarly, also in the power storage device 1b of FIG. 5, the surface roughness of the one surface 21a of the second current collector 21 may be greater than that of the other surface 21b of the second current collector 21.

Although preferred embodiments of the present disclosure are described in detail, the present disclosure is not limited to the aforementioned embodiments.

A separator forming material may be applied to the positive electrode active material layer 22 or the negative electrode active material layer 23 to form the separator 13. The first adhesion layer 13b may be partially (discontinuously, intermittently) provided on the first surface 13aa of the base material layer 13a. The second adhesion layer 13c may be partially (discontinuously, intermittently) provided on the second surface 13ab of the base material layer 13a.

The spacer 14 may be a frame that is formed by combining a plurality of members to surround the positive electrode active material layer 22 or the negative electrode active material layer 23. The spacer 14 may be positioned discontinuously along the edge portion 20e of the first current collector 20 or the edge portion 21e of the second current collector 21. In this case, a material of the spacer 14 can be reduced.

In the cell stack 5 in which the power storage cells 2 are stacked, the edge portion 20e of the first current collector 20 and the edge portion 21e of the second current collector 21 may be exposed from the spacer 14. In this case, the material of the spacer 14 can be reduced as compared with a configuration in which the edge portion 20e of the first current collector 20 and the edge portion 21e of the second current collector 21 are embedded in the spacer 14.

A metal layer 15 may be provided on an outer surface (outer peripheral surface) of the spacer 14. The metal layer 15 extends in the stacking direction from the first current collector 20 disposed at one end of the cell stack 5 in the stacking direction to the second current collector 21 disposed at the other end of the cell stack 5 in the stacking direction. The metal layer 15 may be laminated on the outer surface of the spacer 14 via the adhesion layer 16, for example, or may come in contact with the outer surface of the spacer 14 without interposing the adhesion layer 16. In this case, the metal layer 15 may be formed by vapor deposition, for example, or may be formed by a metal foil being joined to the outer surface of the spacer 14 by welding. After formation of the sealing body 14a, the metal layer 15 is laminated on the outer surface of the sealing body 14a (the outer surface of the spacer 14) via the adhesion layer 16, for example. A resin layer 17 may be further provided on the outer surface of the metal layer 15.

The metal layer 15 can prevent gas such as water vapor or oxygen from passing through the spacer 14. As a result, deterioration of the battery performance of the power storage devices 1, 1a, 1b due to the gas can be prevented.

The spacer 14 may contain ceramic or the like as an insulating material. The spacer 14 may be made of a highly elastic material such as rubber.

The negative electrode unit U2 may be prepared before or after preparation of the positive electrode unit U1, or may be prepared at the same time as the preparation of the positive electrode unit U1.

The positive electrode unit U1 need not have a separator 13. In this case, the separator 13 may be disposed between the positive electrode unit U1 and the negative electrode unit U2 in the stacking process of the positive electrode unit and the negative electrode unit.

In FIG. 3, the power storage device 1 may be charged and discharged without being held.

When the power storage device 1a of FIG. 4 is manufactured, in the activation process in which the power storage device 1a is charged and discharged, the pair of holding plates 31, the bolts 32, and the nuts 33 may be used instead of the pair of holding members 30. In this case, holding of the power storage device 1a using the pair of holding plates 31 need not be released after the activation process.

### REFERENCE SIGNS LIST

1, 1a, 1b power storage device
2 power storage cell
5 cell stack (stacked body)
11 positive electrode (first electrode)
12 negative electrode (second electrode)
13 separator
13a base material layer
13aa first surface
13ab second surface
13b first adhesion layer
13c second adhesion layer
13d central portion
13e, 20e, 21e edge portion
14 spacer
15 metal layer
20 first current collector
20a, 21a one surface
20b, 21b the other surface
20aa, 21aa adhesion surface
21 second current collector
22 positive electrode active material layer (first active material layer)
23 negative electrode active material layer (second active material layer)
25 resin frame
31 holding plate
S space
U1 positive electrode unit (first electrode unit)
U2 negative electrode unit (second electrode unit)

1. A power storage cell comprising:
a positive electrode having a first current collector and a positive electrode active material layer provided on one surface of the first current collector;
a negative electrode having a second current collector and a negative electrode active material layer provided on one surface of the second current collector, the negative electrode being stacked on the positive electrode such that the negative electrode active material layer faces the positive electrode active material layer;
a separator disposed between the positive electrode and the negative electrode and having a base material layer; and
a spacer positioned between the first current collector and the second current collector and joined to at least one of the first current collector and the second current collector, wherein
the separator has a central portion overlapping with the positive electrode active material layer and the negative electrode active material layer as viewed in a stacking direction of the positive electrode and the negative electrode, and an edge portion surrounding the central portion without overlapping the positive electrode active material layer and the negative electrode active material layer,
the separator has, at least in the edge portion of the separator, a first adhesion layer provided on a first surface of the base material layer, and a second adhesion layer provided on a second surface of the base material layer,
one of the first current collector and the second current collector is adhered to the first adhesion layer in the edge portion of the separator, and
the spacer is adhered to the second adhesion layer in the edge portion of the separator.

2. The power storage cell according to claim 1, wherein
the first adhesion layer and the second adhesion layer are provided to the central portion of the separator.

3. The power storage cell according to claim 1, wherein
one of the first adhesion layer and the second adhesion layer is adhered to one of the positive electrode active material layer and the negative electrode active material layer, and
the other of the first adhesion layer and the second adhesion layer is adhered to the other of the positive electrode active material layer and the negative electrode active material layer.

4. The power storage cell according to claim 1, wherein
the spacer is adhered to an end surface of the first adhesion layer and an end surface of the second adhesion layer.

5. The power storage cell according to claim 1, wherein
at least one of the first adhesion layer and the second adhesion layer contains a thermosetting adhesive.

6. The power storage cell according to claim 1, wherein
the first adhesion layer is adhered to the one surface of the second current collector.

7. The power storage cell according to claim 1, wherein
in one of the first current collector and the second current collector adhered to the first adhesion layer, a surface roughness of the one surface is greater than a surface roughness of the other surface opposite to the one surface.

8. A power storage device comprising
a stacked body including a plurality of power storage cells being stacked, wherein
the plurality of power storage cells include the power storage cell according to claim 1.

9. The power storage device according to claim 8 further comprising
a metal layer provided on an outer surface of the spacer of each of the power storage cells.

10. The power storage device according to claim 8, further comprising:
a pair of holding plates sandwiching the stacked body in a stacking direction of the stacked body; and
a current collector plate disposed between each of the pair of holding plates and the stacked body.

11. A method for manufacturing a power storage device comprising:
a preparation process in which a first electrode unit including a first electrode having a first current collector and a first active material layer provided on one surface of the first current collector is prepared;
a preparation process in which a second electrode unit including a second electrode and a spacer is prepared, the second electrode having a second current collector and a second active material layer provided on one surface of the second current collector and having a polarity different from a polarity of the first electrode, the spacer being joined to an edge portion of the second current collector;
a stacking process in which the first electrode unit and the second electrode unit are stacked such that the second active material layer faces the first active material layer with the separator interposed between the second active material layer and the first active material layer, wherein
the separator includes a base material layer, a first adhesion layer provided on a first surface of the base material layer, and a second adhesion layer provided on a second surface of the base material layer,
the edge portion of the separator is disposed between the one surface of the second current collector and the spacer,
the first adhesion layer in the edge portion of the separator faces the one surface of the second current collector, and
the second adhesion layer in the edge portion of the separator faces the spacer;
a forming process in which a sealing body that seals a space between the first electrode and the second electrode is formed by the spacer and another spacer disposed side by side in the stacking direction of the first electrode unit and the second electrode unit being joined to each other by welding; and
a charging and discharging process in which a power storage device including the first electrode, the second electrode, and the separator is charged and discharged after the formation of the sealing body.
